(19) United States
(12) Patent Application Publication
(10) Pub. No.: US 2009/0067804 A1
(43) Pub. Date: Mar. 12, 2009

(54) Splitting Apparatus and Manipulating Apparatus for Optical Waveguides

(76) Inventors: Jens Knorr, Werdohl (DE); Thorsten Muller, Menden (DE); Roman Arnold Theodor Syplacz, Hagen (DE); Wolf Kluwe, Iserlohn (DE); Oliver Lapp, Wuppertal (DE); Michael Muller, Menden (DE); Simon Thibault, Hagen (DE)

Correspondence Address: CORNING INCORPORATED, INTELLECTUAL PROPERTY DEPARTMENT, SP-TI-3-1, CORNING, NY, 14831, US

(21) Appl. No.: 12/250,009

(22) Filed: Oct. 13, 2008

Related U.S. Application Data
(63) Continuation of application No. PCT/EP2007/002780, filed on Mar. 29, 2007.

(30) Foreign Application Priority Data
Apr. 11, 2006 (DE) DE202006006016.2

(51) Int. Cl. G02B 6/00

(52) U.S. Cl. 385/137

(57) ABSTRACT

A splitting apparatus and manipulating apparatus for optical waveguides is disclosed. The splitting apparatus has a bottom plate, a first side and a second side. At least one bundled core guide device, which is used for guiding and/or restraining a plurality of bundled cores, can be inserted into a first bushing region of a splitting apparatus on the first side in such a way that the bundled core guide device latches detachably with ribs and/or the bottom plate of the respective first bushing region. A second bushing region can receive the optical waveguides on the second side, wherein the optical waveguides are individual or loose from the bundled cores.

### CROSS-REFERENCE TO RELATED APPLICATIONS

This application is a continuation of International Application No. PCT/EP2007/002780, filed Mar. 29, 2007, which claims priority to German Application No. DE202006006016.2, filed Apr. 11, 2006, both applications being incorporated herein by reference.

### BACKGROUND

1. Technical Field

The invention relates to optical devices, and more particularly to a splitting apparatus for optical waveguides, and further to a manipulating apparatus for optical waveguides.

2. Technical Background

WO 2004/051337 A1 has disclosed a cable sleeve for laying optical waveguides guided in fiberoptic cables which comprises, in a region below splicing cassettes, two splitting apparatuses for optical waveguides which are positioned back to back. Each of the splitting apparatuses has a basic body, which has, on a first side, a plurality of first bushing regions for bundled cores of optical waveguides and, on a second side, second bushing regions for individual or loose optical waveguides. As can be seen in particular from FIG. 32 of WO 2004/051337 A1, the first bushing regions of the basic body of the splitting apparatus are formed by ribs, which protrude from a bottom plate of the basic body. In each case two adjacent ribs, together with the bottom plate of the basic body, delimit a first bushing region, in which bundled cores of optical waveguides can be guided. The fixing of the bundled cores in the region of the first bushing regions takes place via holding platelets which can be pushed into guide grooves associated with adjacent ribs. As a result of the holding platelets being pushed into the guide grooves of the ribs, each first bushing region can be split in order to fix a plurality of bundled cores therein.

In the case of the splitting apparatus known from WO 2004/051337 A1, a large number of small parts, namely a large number of holding platelets, need to be provided in order to fix bundled cores in the first bushing regions. If a bundled core is intended to be fixed in a first bushing region, first of all the bundled core must be inserted into the first bushing region, then a holding platelet must be pushed into said bushing region in order to fix the bundled core in the first bushing region. This is complex and laborious.

Furthermore, the splitting apparatus for optical waveguides known from WO 2004/051337 A1 has restricted flexibility in the region of the first bushing regions for the bundled cores since all of the bundled cores need to be fixed in a first bushing region in the same laborious manner.

A manipulating apparatus for optical waveguides is known from EP 1 181 604 B1. Since the manipulating apparatus in accordance with EP 1 181 604 B1 in principle has the same design as the splitting apparatus in accordance with WO 2004/051337 A1 in the region of the first bushing regions, it also has the same disadvantages.

### SUMMARY OF THE DETAILED DESCRIPTION

The embodiments disclosed in the detailed description include a splitting apparatus and manipulating apparatus for optical waveguides. The splitting apparatus has a bottom plate, a first side and a second side. At least one bundled core guide device, which is used for guiding and/or restraining a plurality of bundled cores, can be inserted into a first bushing region of a splitting apparatus on the first side in such a way that the bundled core guide device latches detachably with ribs and/or the bottom plate of the respective first bushing region. A second bushing region can receive the optical waveguides on the second side, wherein the optical waveguides are individual or loose from the bundled cores.

At least one bundled core guide device can be inserted into each bushing region for bundled cores. The bundled core guide device can be provided in advance with bundled cores outside the region of the splitting apparatus. Such a bundled core guide device which has been provided in advance with bundled cores can then be positioned in the respective bushing region of the splitting apparatus. As a result, the manipulation and laying of bundled cores is simplified. Furthermore, bundled core guide devices with different designs can be arranged in the bushing regions of the splitting apparatus, as a result of which the flexibility thereof is increased. Furthermore, the number of parts required is reduced, which likewise simplifies manipulation of the splitting apparatus in comparison with the splitting apparatus known from the prior art.

### BRIEF DESCRIPTION OF THE FIGURES

Exemplary embodiments are explained in more detail with reference to the drawing, in which:

FIG. 1 shows a detail of a cable sleeve with two splitting apparatuses according to the invention for optical waveguides in accordance with a first exemplary embodiment of the invention in a perspective view;

FIG. 2 shows the detail from FIG. 1 without splicing cassettes in a perspective view;

FIG. 3 shows a splitting apparatus according to the invention for optical waveguides in accordance with the first exemplary embodiment of the invention together with bundled cores guide devices in a perspective view;

FIG. 4 shows the splitting apparatus from FIG. 3 without bundled core guide devices in a perspective view;

FIG. 5 shows a detail of the splitting apparatus from FIGS. 3 and 4 with bundled core guide devices in a perspective view;

FIG. 6 shows the detail from FIG. 5 with a bundled core guide device in a perspective view;

FIG. 7 shows an arrangement of two bundled core guide devices together with a closure element in a first perspective view;

FIG. 8 shows the arrangement from FIG. 7 in a second perspective view;

FIG. 9 shows the arrangement from FIG. 7 in an exploded illustration;

FIG. 10 shows a bundled core guide device in a front view;

FIG. 11 shows the bundled core guide device from FIG. 10 in a side view;

FIG. 12 shows the bundled core guide device from FIG. 10 in a plan view;

FIG. 13 shows a closure element in a front view;

FIG. 14 shows the closure element from FIG. 13 in a side view;

FIG. 15 shows the closure element from FIG. 13 in a view from below;

FIG. 16 shows an alternative bundled core guide device in a perspective view;

FIG. 17 shows a further alternative bundled core guide device in an exploded illustration;

FIG. 18 shows a splitting apparatus according to the invention for optical waveguides in accordance with the second exemplary embodiment of the invention together with bundled core guide devices in a perspective view;

FIG. 19 shows a bundled core guide device of the splitting apparatus from FIG. 18 in a first perspective view; and

FIG. 20 shows the bundled core guide device from FIG. 19 in a second perspective view.

### DETAILED DESCRIPTION

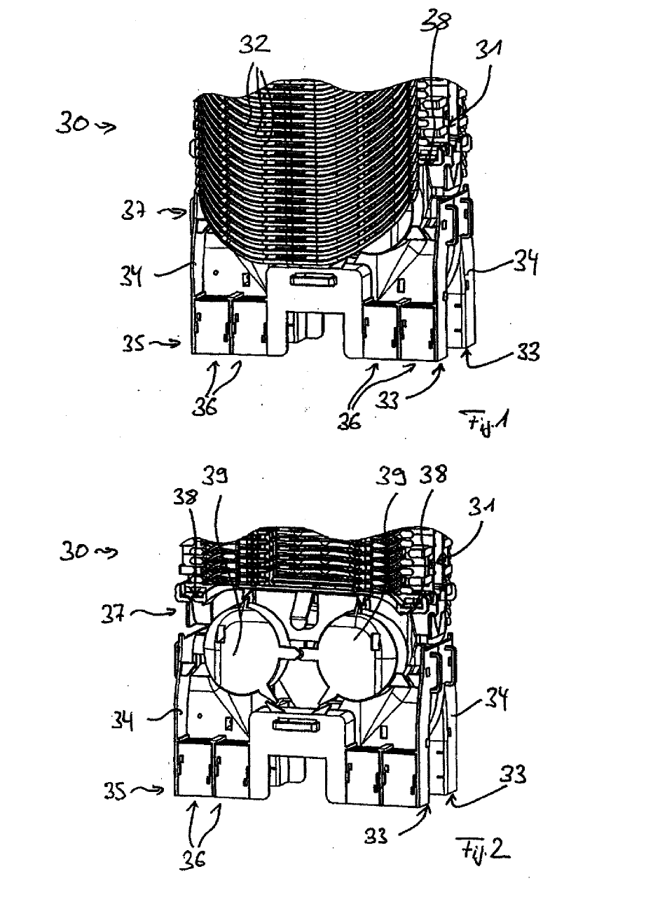

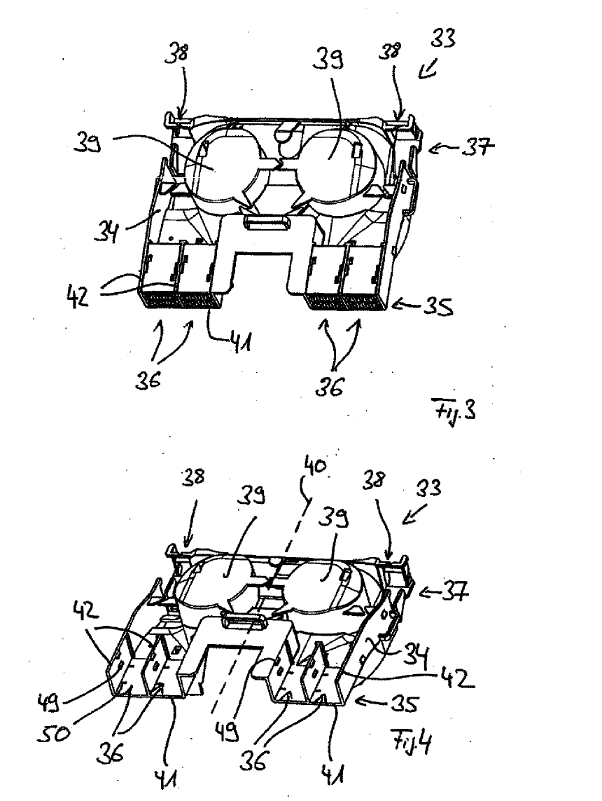

FIGS. 1 and 2 show a detail of a cable sleeve 30, which comprises, below an accommodating apparatus 31 for splicing cassettes 32, two splitting apparatuses 33 according to the invention for optical waveguides. The two splitting apparatuses 33 are positioned back to back. Such a splitting apparatus 33 is illustrated on its own in FIGS. 3 and 4.

The splitting apparatus 33 according to the invention has a basic body 34, the basic body 34 having, on a first side 35, first bushing regions 36 for optical waveguides, namely for optical waveguides which are combined to form bundled cores. On a second side 37 which is opposite the first side 35, the basic body 34 has second bushing regions 38 for optical waveguides, namely for individual or loose optical waveguides.

In the exemplary embodiment shown, two drum-like guide devices 39 are arranged between the first side 35 and the second side 37 of the splitting apparatus 34, and therefore between the first bushing regions 36 and the second bushing regions 38, which guide devices 39 can be used to guide optical waveguides, which, when combined to form bundled cores, are fed to the splitting apparatus 33 via the first bushing regions 36 and, as loose optical waveguides, are guided away therefrom via the second bushing regions 38, whilst maintaining permissible minimum bending radii. The drum-like guide devices 39 accordingly form an excess length store for optical waveguides.

The splitting apparatus 33 is designed to be symmetrical with respect to an imaginary partition line 40 (see FIG. 4), which extends between the two drum-like guide devices 39. In the exemplary embodiment shown, in each case one drum-like guide device 39, in each case one second bushing region 38 and in each case two first bushing regions 36 for optical waveguides are arranged on both sides of the imaginary partition line 40.

The embodiment now relates to those details of the splitting apparatus 33 which relate to the guidance and restraint of bundled cores in the region of the first bushing regions 36. However, these details are not restricted to the splitting apparatus illustrated in the drawing, but can also be used for manipulating apparatuses which do not have second bushing regions and do not have drum-like guide devices.

Each first bushing region 36 of the splitting apparatus 33 is formed by a bottom plate 41 of the basic body 34 and by in each case two ribs 42 protruding from the bottom plate 41. In each case two directly adjacent ribs 42 and the bottom plate 41 accordingly delimit in each case one first bushing region 36 for optical waveguides which are combined to form bundled cores. In the exemplary embodiment shown, the splitting apparatus 33 accordingly has four first bushing regions 36 in the region of the first side 35, with in each case two first bushing regions 36 being arranged on each side of the imaginary partition line 40.

In the context of the embodiment, in each case at least one bundled core guide device 43, which is used for guiding and restraining a plurality of bundled cores, can be inserted into each first bushing region 36 in such a way that the respective bundled core guide device 43 latches detachably, via latching means associated therewith, with the ribs 42 and/or the bottom plate 41 of the respective first bushing region 36.

The bundled core guide devices 43 can be provided with bundled cores in advance outside the region of the first bushing regions 36 and then inserted, together with the bundled cores, into the first bushing regions 36. This simplifies the manipulation considerably in comparison with the prior art. Since, furthermore, a plurality of bundled cores can be guided and restrained in a bundled core guide device 43, the number of individual parts required is also reduced in comparison with the prior art.

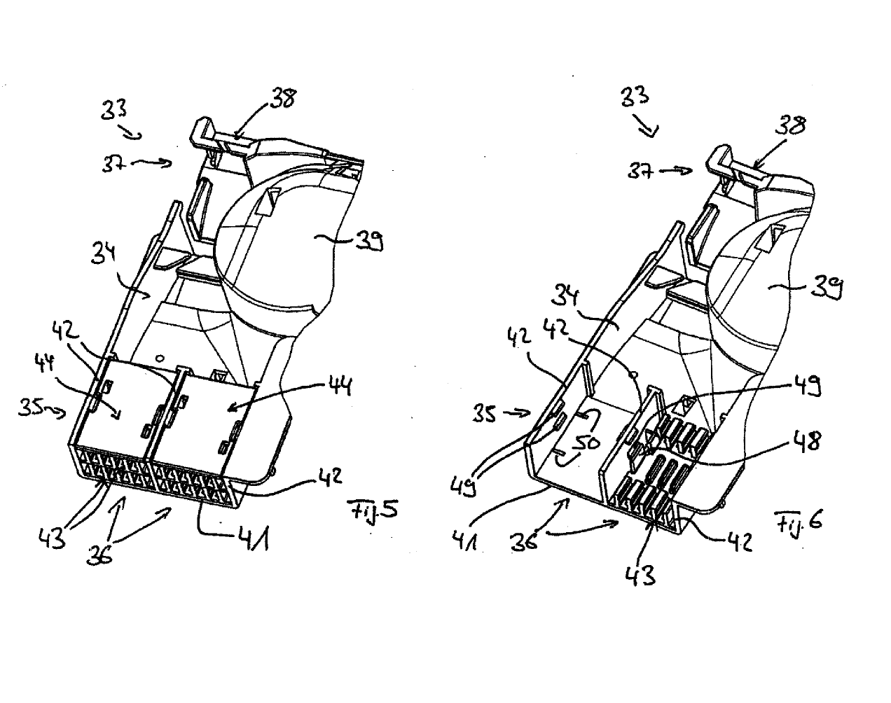

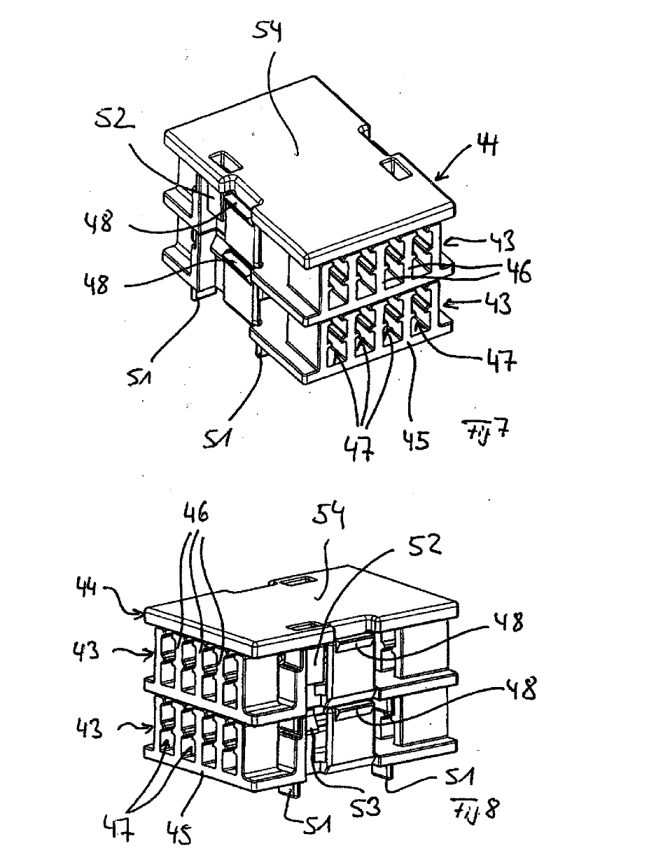

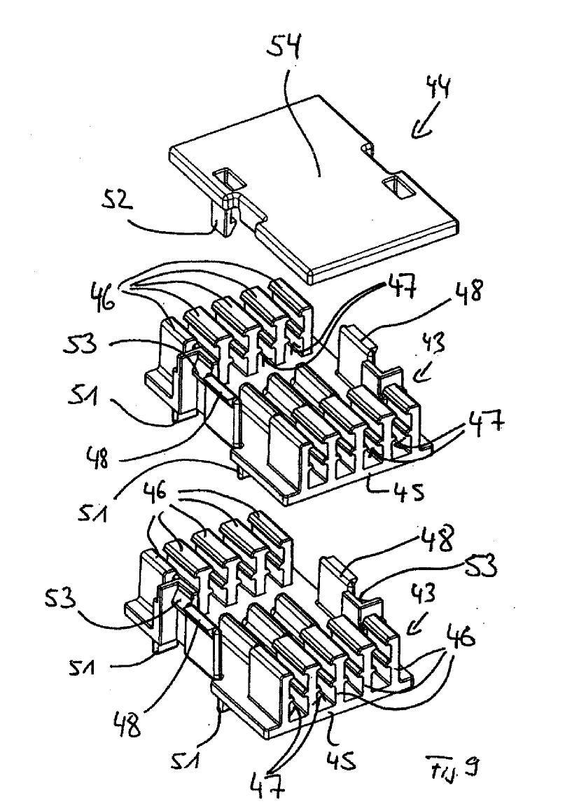

In the exemplary embodiment shown in FIGS. 1 to 6, two bundled core guide devices 43 can be inserted one above the other into each first bushing region 36. The bundled core guide device 43 arranged at the very top in the respective first bushing region 36 can be closed by a closure element 44 on an upper side. FIGS. 7 and 8 each show an arrangement of two bundled core guide devices 43 and a closure element 44, which can be inserted into a first bushing region 36. FIG. 9 shows such an arrangement in an exploded illustration.

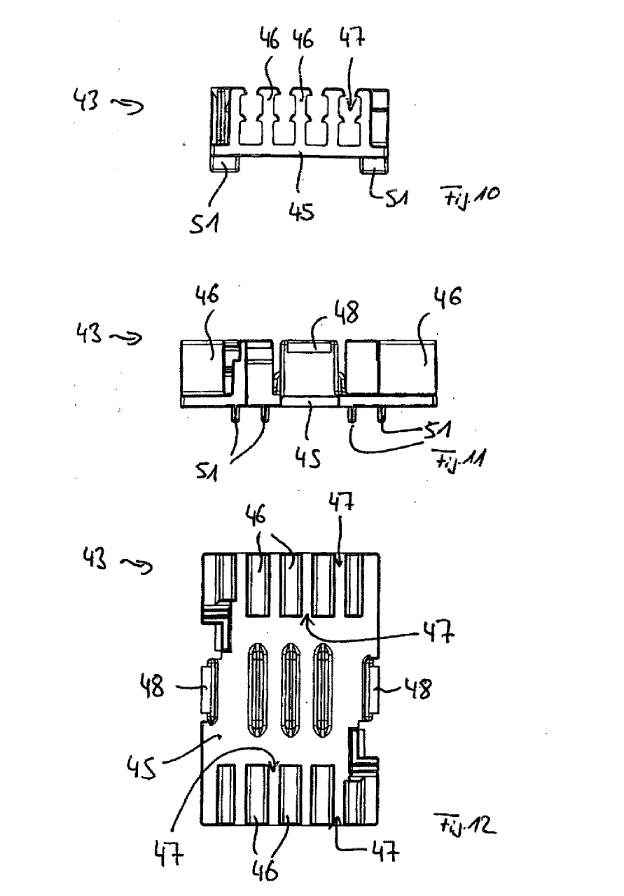

In the exemplary embodiment shown in FIGS. 1 to 12, each bundled core guide device 43 has a base plate 45, in each case webs 46 protruding from the base plate 45 on opposite sides thereof. Adjacent webs 46 in this case each form an accommodating region 47 for bundled cores, with it being possible for in each case at least one bundled core to be guided and restrained in each of the accommodating regions 47.

On two further opposite sides, latching means 48, which in the exemplary embodiment shown are in the form of barb-like latching hooks, protrude from the base plate 45 of a bundled core guide device 43. Each bundled core guide device 43 can be latched detachably, via the latching hooks, in a first bushing region 36, with the latching hooks 48 of the bundled core guide devices 43 latching with latching means 49, which are associated with the ribs 42 of the first bushing regions 36, as shown in FIGS. 1 to 6. The latching means 49 associated with the ribs 42 are in this case in the form of latching tabs, with each latching hook 48 of a bundled core guide device 43 latching detachably with a latching tab 49 of a rib 42.

The arrangement of a first bundled core guide device 43 in a first bushing region 36 which is still free is simplified by virtue of the fact that cutouts 50 are introduced into the bottom plate 41, with the bundled core guide device 43 engaging into said cutouts with projections 51, which protrude with respect to the base plate 45 on a lower side thereof.

As has already been mentioned, the bundled core guide device 43 arranged at the very top in a first bushing region 36 can be closed by the closure element 44 on an upper side, the closure element 44 latching, via latching means 52 which are associated therewith and are in the form of latching hooks, with corresponding latching means 53 of the bundled core guide device 43 arranged at the very top. The latching means 53 of the bundled core guide devices 43 which can latch with the latching means 52 of a closure element 44 are in the form of latching tabs. The latching means 52 in the form of latching hooks of the closure element 44 protrude from a base plate 54 of the closure element 44.

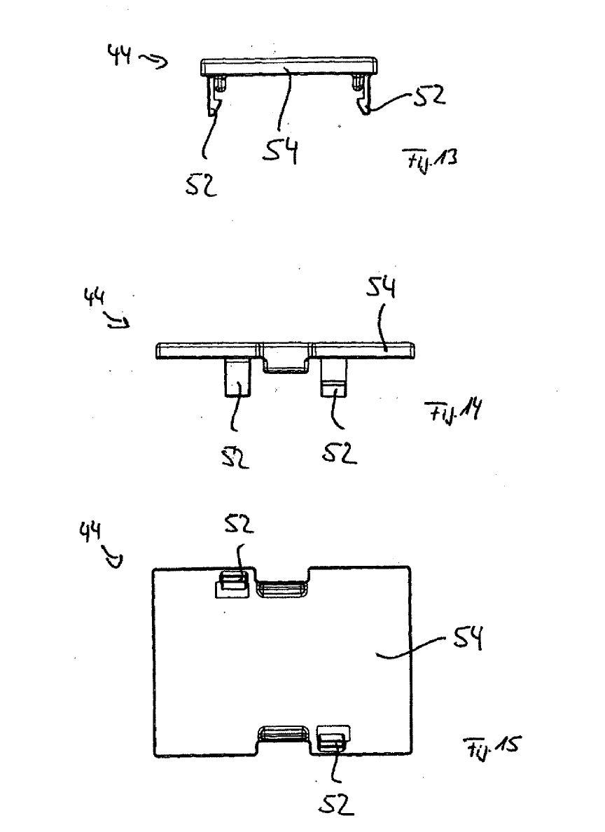

One advantage of the splitting device 33 according to the invention for optical waveguides can be considered to be the fact that bundled core guide devices of any design can be arranged in the first bushing regions 36. The bundled core guide devices 43 illustrated in connection with FIGS. 1 to 15 merely represent a preferred exemplary embodiment thereof.

Furthermore, it shall be mentioned that only a single first bushing region can be formed on each side of the imaginary partition line 40, in this case the central rib 42 then being dispensed with in each case. Also, more than two first bushing regions can be formed on both sides of the imaginary partition line 40.

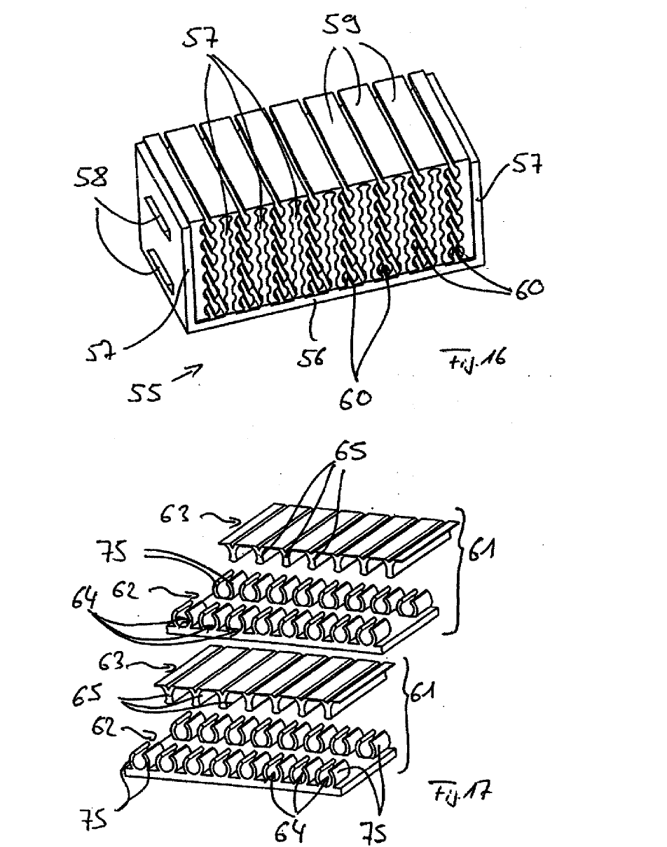

FIG. 16 shows an alternative embodiment of a bundled core guide device 55 which can be positioned in a first bushing region. The bundled core guide device 55 illustrated in FIG. 16 is dimensioned in such a way that it completely fills a first bushing region, with the result that, accordingly, only one such bundled core guide device 55 can be positioned in a first bushing region.

The bundled core guide device 55 illustrated in FIG. 16 has a width which extends over two of the first bushing regions 36 illustrated in FIGS. 1 to 6, with the result that said bundled core guide device 55 is accordingly used when there are no central ribs 42 if, accordingly, only a single first bushing region 36 is provided on one side of the imaginary partition line 40.

The bundled core guide device 55 from FIG. 16 has a base plate 56, from which webs 57 protrude. The respectively outermost webs 57 have latching means 58, which interact with the latching means 49 associated with the ribs 42. The webs 57 positioned between the two outer webs 57 have a corrugated profile. As shown in FIG. 16, the two outer webs 57 are coated on one side with an elastic material 59 and the central webs 57 are in each case coated on both sides with an elastic material 59. Accommodating regions 60 for bundled cores are formed between in each case two adjacent webs 57 or between the elastic material 58, with which adjacent webs 57 are coated. In this case, as shown in FIG. 16, a plurality of bundled cores can be guided and restrained between in each case two adjacent webs 57 or the elastic material 59 thereof.

A further variant of a bundled core guide device 61 which can be positioned in a first bushing region is shown in FIG. 17, with each of the bundled core guide devices 61 illustrated in FIG. 17 comprising a bottom part 62 and a cover part 63. The bottom part 62 has a plurality of accommodating regions 64 with a C-shaped contour for bundled cores which are delimited by bent webs 75, which protrude from a base plate 76. The cover part 36 has webs 65, which can be inserted between two webs 75 of adjacent accommodating regions 64. The cover part 36 is preferably produced from an elastic material, with the result that it can be pulled off from the bottom part 62 in order to selectively expose an accommodating region 64, while other accommodating regions 64 remain covered by the elastic cover part 63 and therefore closed.

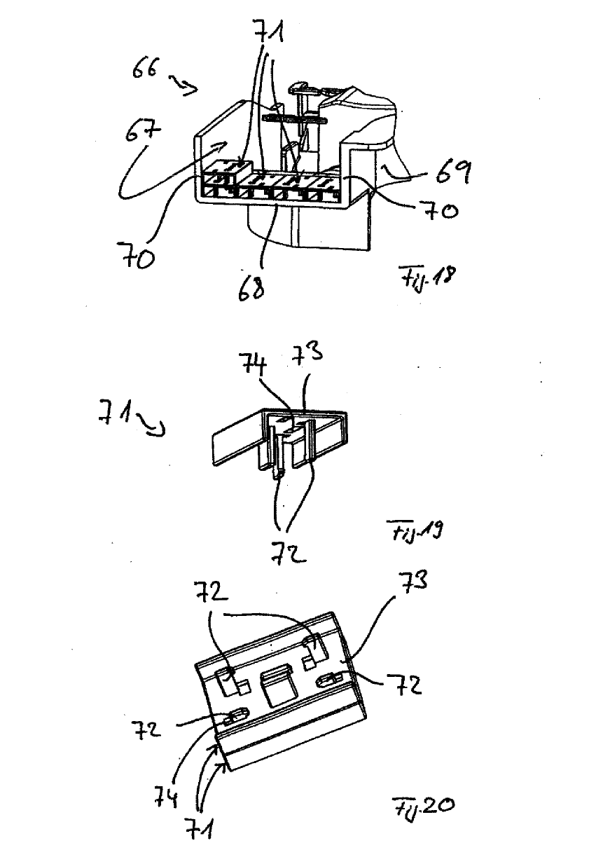

FIG. 18 shows a detail of a splitting apparatus 66 according to the invention in accordance with a second exemplary embodiment of the invention in the region of a first bushing region 67. The first bushing region 67 is in turn delimited by a bottom plate 68 of a basic body 69 of the splitting apparatus 66 and by two ribs 70 protruding from the bottom plate 68. As shown in FIG. 18, a plurality of bundled core guide devices 71 for guiding and restraining bundled cores can be arranged in the first bushing region 67. FIGS. 19 and 20 show such a bundled core guide device 71, in each case illustrated on its own.

In the exemplary embodiment in FIGS. 18 to 20, the bundled core guide devices 71 can in turn be latched with the first bushing region 67 for the bundled cores, with latching means 72 of the bundled core guide devices 71 which are in the form of latching hooks either latching with latching means associated with the bottom plate 68 or with latching means which are associated with a bundled core guide device 71 which is already arranged in the respective first bushing region 67, in the exemplary embodiment in FIGS. 18 to 20. These latching means are cutouts which have been introduced into the bottom plate 68 or into a base plate 73 of the bundled core guide devices 71, into which cutouts the latching hooks 72 of the bundled core guide devices 71 can snap. FIGS. 18 to 20 merely show the cutouts 74 which have been introduced into the base plate 73 of the bundled core guide devices 71.

What is claimed is:

1. A splitting apparatus for optical waveguides, comprising:
a bottom plate, first side and a second side;
at least one first bushing region for receiving optical waveguides combined to form bundled cores on the first side, wherein the at least one first bushing region is formed by two ribs which protrude from the bottom plate;
at least one bundled core guide device for guiding and/or restraining a plurality of bundled cores inserted into the at least one first bushing region such that the at least one bundled core guide device latches detachably with the ribs and/or the bottom plate; and
at least one second bushing region for receiving the optical waveguides on the second side, wherein the optical waveguides are individual or loose from the bundled cores.

2. The splitting apparatus of claim 1, wherein the at least one bundled core guide device comprises bundled core guide device latching means, which latch with rib latching means associated with the ribs and/or bottom plate latching means associated with the bottom plate.

3. The splitting apparatus of claim 2, wherein the bundled core guide device latching means are latching hooks and the rib latching means are latching tabs.

4. The splitting apparatus of claim 2, further comprising a plurality of bundled core guide devices, wherein the a plurality of bundled core guide devices can be inserted one above the other into the at least one first bushing region, each of the plurality of bundled core guide devices arranged one above the other in the at least one first bushing region to latch via their respective bundled core guide device latching means with the rib latching means.

5. The splitting apparatus of claim 4, further comprising a closure element arranged on the at least one bundled core guide device at the top in the at least one first bushing region and comprising closure element latching means, such that the closure element latching means are in the form of latching hooks and latch with bundled core guide device latching means in the form of latching tabs.

6. The splitting apparatus of claim 1, wherein the at least one bundled core guide device comprises a bundled core guide device base plate and a plurality of webs protruding from the bundled core guide device base plate, wherein two adjacent webs define one accommodating region for at least one of the plurality of bundled cores, such that the plurality of bundled cores can be guided and/or or restrained next to one another and possibly one above the other using the at least one bundled core guide device.

7. The splitting apparatus of claim 6, wherein the plurality of webs is coated with an elastic material.

8. The splitting apparatus of claim 1, further comprising at least one drum-like guide device for optical waveguides arranged between the first side and the second side, which guide device can be used to guide optical waveguides while maintaining permissible minimum bending radii.

9. A manipulating apparatus for optical waveguides, comprising:
a plurality of ribs protruding from a bottom plate, wherein two adjacent ribs define a bushing region for optical waveguides combined to form bundled cores; and
at least one bundled core guide device used for guiding and/or restraining a plurality of bundled cores, wherein the at least one bundled core guide device can be inserted into the bushing region in such a way that the bundled core guide device latches detachably with the ribs and/or the bottom plate.

10. A method for guiding optical waveguides, comprising the steps of:
providing at least one first bushing region for receiving bundled cores of optical waveguides on a first side, wherein the at least one first bushing region is formed by two ribs which protrude from a bottom plate;
latching detachably into the at least one first bushing region at least one bundled core guide device for guiding and/or restraining a plurality of bundled cores inserted in the at least one bundled core guide device; and
providing at least one second bushing region for receiving the individual or loose optical waveguides on the second side, wherein the optical waveguides are from the bundled cores.
